(19) United States
(12) Patent Application Publication
(10) Pub. No.: US 2016/0259591 A1
(43) Pub. Date: Sep. 8, 2016

(54) STORAGE SYSTEM AND DEDUPLICATION CONTROL METHOD

(71) Applicants: HITACHI, LTD., Chiyoda-ku, Tokyo (JP); HITACHI INFORMATION & TELECOMMUNICATION ENGINEERING LTD., Yokohama-shi, Kanagawa (JP)

(72) Inventors: Hidehisa ARIKAWA, Kanagawa (JP); Naomitsu TASHIRO, Kanagawa (JP); Mikito OGATA, Kanagawa (JP)

(73) Assignees: HITACHI, LTD., Tokyo (JP); Hitachi Information & Telecommunication Engineering Ltd., Yokohama-shi, Kanagawa (JP)

(21) Appl. No.: 14/652,577

(22) PCT Filed: Dec. 24, 2013
(86) PCT No.: PCT/JP13/84518

§ 371 Date: Jun. 16, 2015

(51) Int. Cl. G06F 3/06

(52) U.S. Cl. CPC G06F 3/0641; G06F 3/0608; G06F 3/0683

(57) ABSTRACT

A storage system, in a write process of a file, stores the file in a memory and selects whether or not to perform a deduplication process of a chunk based on whether or not at least one of an attribute of the file and a usage capacity at a time of a chunk being read from the memory satisfies a predetermined condition, with respect to each of multiple chunks composing the file. With respect to the chunks which are selected not to perform a deduplication process, a deduplication process may be performed asynchronously from a write process.

### TECHNICAL FIELD

The present invention generally relates to storage control, for example, deduplication of files.

### BACKGROUND ART

With respect to deduplication of files, for example, Patent Literature 1 has been well known. Patent Literature 1 discloses technology using both a post-process method and an inline method. The post-process method is a method which, after writing a file to a storage device, asynchronously performs a deduplication process for the file. The inline method is a method which, before writing a file to a storage device, performs a deduplication process for the file.

### CITATION LIST

### Patent Literature

[PTL 1] US2011/0289281

### SUMMARY OF INVENTION

### Technical Problem

With respect to the post-process method, the process performance of a whole storage device is dependent on the write performance of the storage device, since all files are once written to the storage device. Meanwhile, with respect to the inline process, the process performance of a whole storage device is dependent on the performance of a deduplication process, since the deduplication process is performed when the file is written to the storage device.

### Solution to Problem

A storage system, in a write process of a file, stores the file in a memory and selects, with respect to each of multiple chunks which configure the file, whether or not to perform a deduplication process of a chunk based on whether or not at least one of an attribute of the file and a usage capacity at a time of the chunk being read from the memory satisfies a predetermined condition. With respect to the chunks which are selected not to perform the deduplication process, the deduplication process may be performed asynchronously from the write process.

### Advantageous Effects of Invention

It can be expected to realize both shortening of the write process time and improvement of the deduplication rate (capacity saving of a storage area) in good balance.

### BRIEF DESCRIPTION OF DRAWINGS

FIG. 1 shows a summary of a storage system according to Embodiment 1.

FIG. 2 is a block diagram to show a hardware configuration of a system according to Embodiment 1.

FIG. 3 is an example of a block diagram to show the function of a storage system according to Embodiment 1.

FIG. 4 is another example of a block diagram to show the function of a storage system according to Embodiment 1.

FIG. 5 shows a configuration of a metadata.

FIG. 6 is a schematic diagram for the function of a primary process unit.

FIG. 7 shows a flow of a file backup process according to Embodiment 1.

FIG. 8 shows a flow of a post-processing

FIG. 9 shows a flow of a synchronous deduplication process

FIG. 10 shows a flow of a deduplication judgment according to Embodiment 1.

FIG. 11 shows a flow of an asynchronous deduplication process

FIG. 12 shows a flow of a read process of a file

FIG. 13 shows a flow of a deduplication judgment according to Embodiment 2

FIG. 14 shows a flow of a deduplication judgment according to Embodiment 3.

FIG. 15 shows a flow of a deduplication judgment according to Embodiment 4.

FIG. 16 shows a flow of a deduplication judgment according to Embodiment 5.

FIG. 17 shows a part of a file backup process according to Embodiment 6.

FIG. 18 shows a first example of a strategy judgment.

FIG. 19 shows a flow of a strategy configuration process.

FIG. 20 shows a second example of a strategy judgment.

FIG. 21 shows a flow of a deduplication judgment according to Embodiment 7.

FIG. 22 shows a flow of a deduplication judgment according to Embodiment 8.

### DESCRIPTION OF EMBODIMENTS

Hereinbelow, several embodiments will be explained.

In the following explanation, information may be explained using an expression such as “xxx table”, but the information may be expressed using any sort of data structures. Which means that “xxx table” can be called “xxx information” to show that the information is not dependent on data structures.

Also, in the following explanation, there is a case to explain a processing by using a “program” as the doer of the action, but a processor may be used as the doer of the action in explaining the processing, since programs are executed by processors and perform stipulated processing by using memories and communication ports (communication interface devices). In addition, the processing disclosed by using a program as the doer of the action may be regarded as the processing performed by an apparatus such as a computer. Also, processors are typically a microprocessor or the core of the microprocessor which executes programs but may include an exclusive hardware which executes a part of processing. In addition, various programs may be installed in a computer by a program delivery server, or a computer-readable storage medium.

Also, in the following explanation, “VOL” is the abbreviation of logical volume and is a logical storage device. The VOLs may be a real VOL (a RVOL) or may be a virtual VOL (a VVOL). In addition, there may be a VOL that is an online VOL which is provided to a host apparatus coupled to a storage apparatus which provide the VOL and a VOL that is an offline VOL which is not provided to a host apparatus (not acknowledged by a host apparatus). “RVOL” is a VOL based on a physical storage resource (for example, a RAID (Redundant Array of Independent (or Inexpensive) Disks) group configured with multiple PDEVs) which the storage apparatus which comprises the RVOL comprises. As “VVOLs”, for example, there may be an externally connected VOL (a EVOL) which is based on a storage resource (for example, a VOL) of an external storage apparatus coupled to the storage apparatus which comprises the VVOL and complies with a storage virtualization technology, a VOL (TPVOL) which is configured with multiple virtual pages (virtual storage areas) and complies with a capacity virtualization technology (typically, Thin Provisioning), and a snapshot VOL which is provided as a snapshot of an original VOL. The TPVOL is typically an online VOL. The snapshot VOL may be a RVOL. “PDEV” is the abbreviation of nonvolatile physical storage device. Multiple RAID groups may be configured with multiple PDEVs. The RAID group may be referred to as the parity group. “Pool” is a logical storage area (for example, a set of multiple Pool VOLs) and may be prepared for each purpose of the usages. For example, as the Pools, there may be a TP Pool and a snapshot Pool. The TP Pool is a storage area configured with multiple real pages (real storage areas). The real pages may be allocated in the virtual pages of the TPVOL from the TP Pool. The snapshot Pool may be a storage area in which the saved data from the original VOL is stored. “Pool VOL” is a VOL which becomes the component of a Pool. The Pool VOL may be a RVOL or an EVOL. The Pool VOL is typically an offline VOL.

Also, in the explanation below, a file system is used as an example of a storage area. The file system is an example of a logical storage area, for example, a VOL.

### Embodiment 1

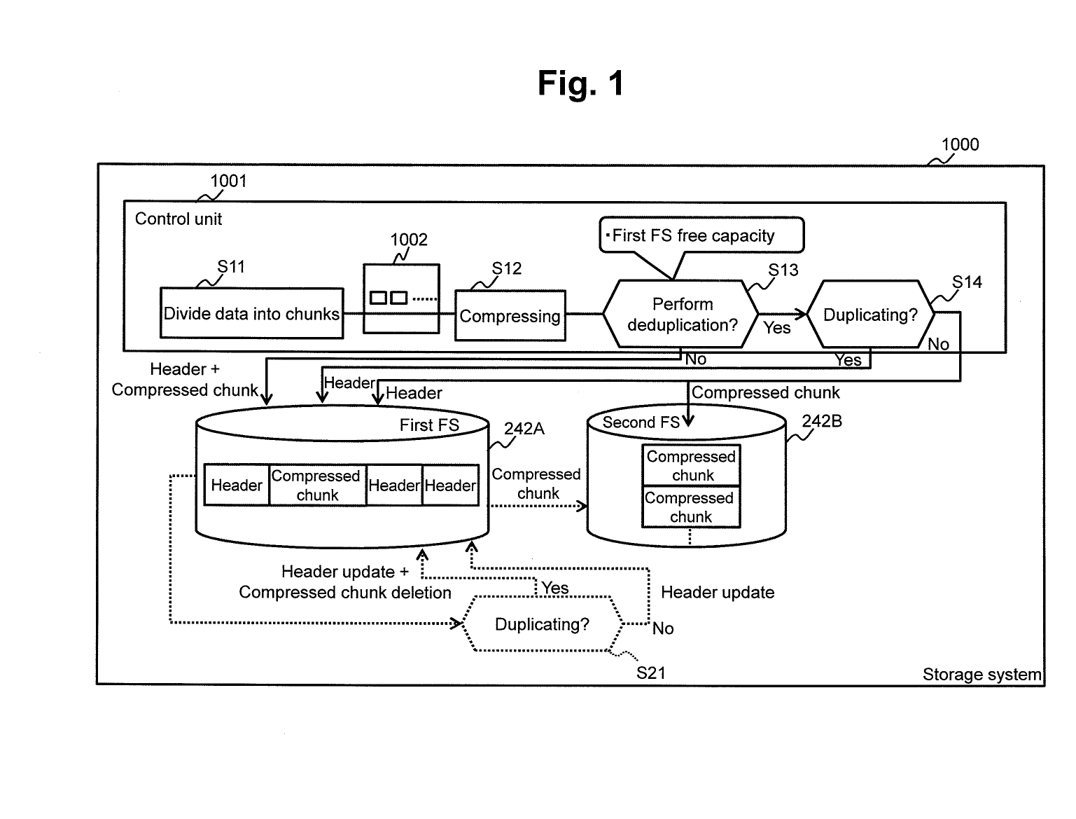

FIG. 1 shows a summary of a storage system according to Embodiment 1.

A storage system 1000 comprises a first file system (“First FS” in the drawing) 242A, a second file system (“Second FS” in the drawing) 242B and a control unit 1001. The control unit 1001 comprises a memory 1002. The first file system 242A is a file system (for example, an online VOL) provided to a host apparatus (no drawings) and the second file system 242B is a file system (for example, an offline VOL) hidden from the host apparatus (hereinafter, referred to as the host).

The control unit 1001, in a write process of a file, stores the file in a memory 1002 after dividing the file into chunks (S11) and performs the following process for each of the chunks in the memory 1002. That is, the control unit 1001 reads a chunk from the memory 1002 and compresses the read chunk (S12). And the control unit 1001, with respect to the chunk which was compressed (the compressed chunk), makes a deduplication judgment on whether or not to perform a deduplication process during the write process (namely, whether or not to perform a synchronous deduplication process) (S13). Specifically, the control unit 1001 decides, in a case where a free capacity of the first file system 242A is less than a predetermined capacity, to perform the deduplication process with respect to the compressed chunk (the judgment result is true) and decides, in a case where a free capacity of the file system 242A is equal to or more than a predetermined capacity, not to perform the deduplication process with respect to the compressed chunk (the judgment result is false). In a case where the judgment result on S13 is false (S13:No), the control unit 1001 writes the compressed chunk and the chunk header thereof in the first file system 242A. On the other hand, in a case where the judgment result on S13 is true (S13:Yes), the control unit 1001 judges whether or not a chunk duplicating the compressed chunk is stored in the second file system 242B (S14). In a case where the judgment result on S14 is true (S14:Yes), the control unit 1001 writes only the chunk header out of the compressed chunk and the chunk header to the first file system 242A. On the other hand, in a case where the judgment result on S14 is false (S14:No), the control unit 1001, out of the compressed chunk and the chunk header, writes the chunk header to the first file system 242A and writes the compressed chunk to the second file system 242B.

The above mentioned S11 through S14 are performed during the write process of the file. Thereby, in the first file system 242A, there will be a case that both the chunk header and the compressed chunk exist, or there will be another case that only the chunk header exists. In addition, the control unit 1001 writes a chunk location, a chunk size and a deduplication flag to the chunk header. The chunk location is a location of a chunk (for example, an offset) in the file. The chunk size is a size (a length) of a chunk. That is, the size of a chunk which is divided from the file may be all the same (fixed size) or may be different sizes (variable size). The deduplication flag is an example of the information which denotes whether or not a deduplication process has been performed with respect to the compressed chunk associated with the chunk header which comprises the flag, for example “1” denotes the deduplication processed and “0” denotes the deduplication unprocessed. Also, the address of the stored location of the compressed chunk which corresponds to the chunk header may be written to the chunk header. The chunk header may be a metadata of the file itself such as an inode.

The control unit 1001 performs an asynchronous deduplication process. That is, the control unit 1001 performs the deduplication process with respect to the compressed chunks in the first file system 242A asynchronously from the write process of the file. Specifically, the control unit 1001 reads the compressed chunk which corresponds to the chunk header which comprises the flag denoting the deduplication unprocessed from the first file system 242A and judges whether or not a duplicate compressed chunk of the compressed chunk is stored in the second file system 242B (S21). In a case where the judgment result on S21 is true (S21:Yes), the control unit 1001 removes the compressed chunk from the first file system 242A, and also updates the flag of the chunk header for the compressed chunk to the deduplication processed. On the other hand, in a case where the judgment result on S21 is false (S21:No), the control unit 1001 shifts the compressed chunk to the second file system 242B, and also updates the flag of the chunk header for the compressed chunk to the deduplication processed.

In a case where the control unit 1001 performed the deduplication process with respect to all the chunks (the compressed chunks) which compose the file, the control unit 1001 creates a stub file of the file and writes the created stub file to the first file system 242A. The stub file is associated with the compressed chunks which compose the file and are in the second file system 242B. In a case where the control unit 1001 is requested to read the file of which the sub file was created, the control unit 1001 reads the compressed chunks associated with the stub file from the second file system 242B, and provides the request-source with the file after decompressing each of the compressed chunks which are read from the second file system 242B. On the other hand, in a case where the control unit 1001 is requested to read the file of which the stub file was not created (the file in which at least one or more compressed chunks exist in the first file system 242A), the control unit 1001 reads the compressed chunks corresponding to the file from the first and the second file systems 242A and 242B, and provides the file with the request-source after decompressing each of the compressed chunks which are read from the first and the second file systems 242A and 242B.

The first file system 242A is an example of a first storage area and the second file system 242B is an example of a second storage area. The first file system 242A is used like a temporary storage area for compressed chunks during the write process, and the compressed chunks in the first file system 242A are removed from the first file system 242A in accordance with the asynchronous deduplication process being performed. In the asynchronous deduplication process, the compressed chunks which are removed from the first file system 242A are written to the second file system 242B when a compressed chunk which duplicates the compressed chunk does not exist in the second file system 242B.

The preceding is the summary of Embodiment 1.

In addition, a deduplication process judgment may be performed prior to the start of the write process and the result of the deduplication process judgment on S13 may remain the same as the result of the deduplication process judgment which was made prior to the start of the write process. The deduplication process judgment prior to the start of the write process may be performed based on an attribute of the file. With respect to an example of the deduplication process judgments prior to the start of the write process, it will be explained in Embodiment 6 in details.

Also, the storage system 1000 may be composed of one or multiple storage apparatuses. The storage apparatus which performs S11 through S13 and the storage apparatus which performs S14 through S21 may be the same apparatus or may be different apparatuses.

In addition, the storage system 1000 may be composed of a storage apparatus and at least a part of the host coupled to the storage apparatus (for example, a memory of the host, a predetermined program among multiple programs and a processor which executes a predetermined program). The host may perform S11 through S13, and write the compressed chunk and the chunk header to the first file system 242A in the case of S13:No, and the storage apparatus may perform S14 through S21. In this case, the memory 1002 may be a memory in the host.

Also, the judgment on S13 is made based on whether or not a free capacity of the first file system 242A is less than a predetermined capacity, but instead of or in addition to the free capacity of the first file system 242A, the judgment on S13 can be made based on a usage capacity of another kind (for example, as being explained in Embodiment 2 through Embodiment 5, a length of a queue which is defined by the number of unprocessed chunks (the number of chunks in a memory)). With respect to the usage capacity which is considered in the judgment on S13, it is preferable to use the capacity which can vary according to the progress of the write process, such as the free capacity and the number of unprocessed chunks in the first file system 242A.

In addition, the definition on whether or not a free capacity of the first file system 242A is less than a predetermined capacity may be the same as whether or not a free capacity rate of the first file system 242A is less than a predetermined capacity rate. The free capacity rate of the first file system 242A is the rate of the free capacity of the first file system 242A against the capacity of the first file system 242A.

Also, the chunks may not necessarily be compressed. But, the usage capacity of the first and the second file systems 242A and 242B can be saved by compressing chunks as described hereinabove. In addition, the file may once be stored in the memory 1002 and may be read from the memory 1002 by a chunk unit instead of the file being divided into chunks beforehand.

Also, an asynchronous deduplication process may not necessarily be performed. But, the usage capacity of PDEV groups of the storage system can be saved by performing the asynchronous deduplication process. In addition, it can be expected to reduce the performance degradation on the write process (and the read process) of the file if the asynchronous deduplication process is performed during the load of the storage system is lower than the predetermined load.

Hereinbelow, Embodiment 1 will be explained in details. In addition, it is supposed here that files are backup files (the files of backup target).

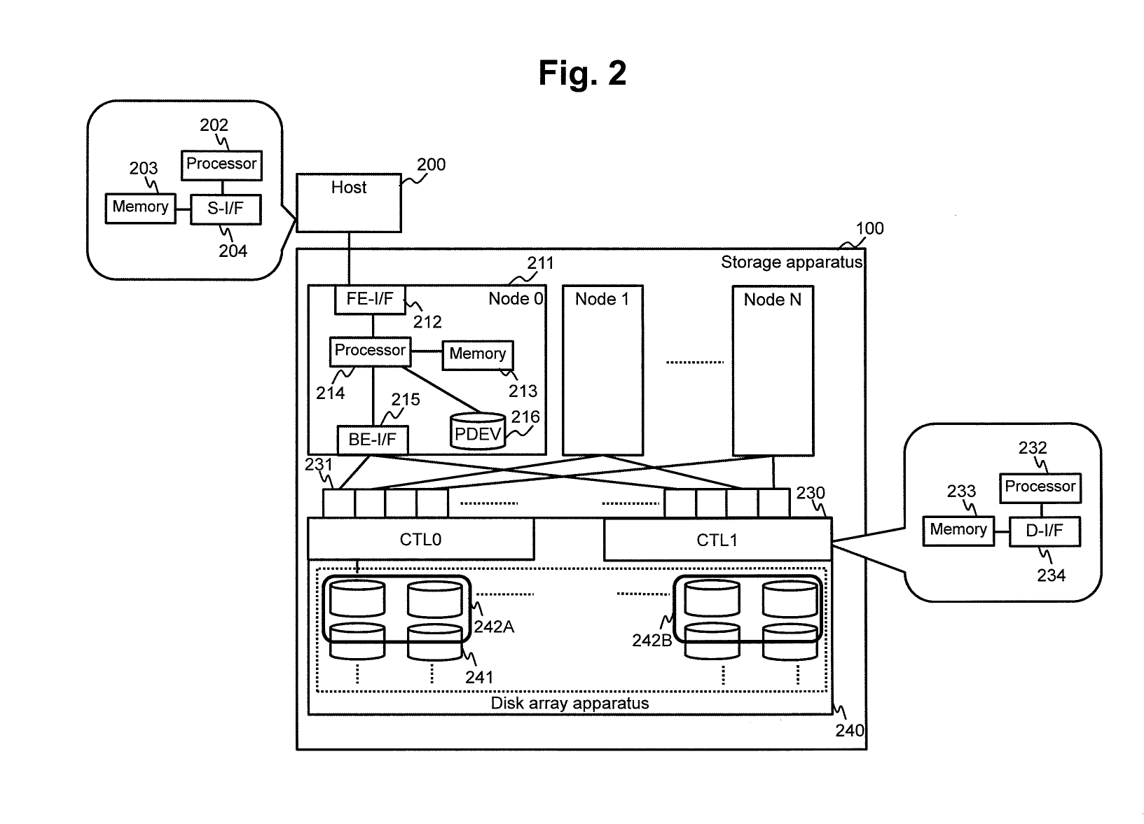

FIG. 2 is a block diagram to show a hardware configuration of a system according to Embodiment 1.

There are a storage apparatus 100, and a host 200 which is coupled to the storage apparatus 100 for example via a communication network (for example SAN (Storage Area Network)).

The host 200 is an apparatus which writes a file to the storage apparatus 100 and reads a file from the storage apparatus 100 by sending a write request and a read request of files. The host 200 is typically a computer, but may be other storage apparatus. The host 200 may comprise an interface device (S-I/F) 204 coupled to the storage 100, a memory 203 and a processor 202 coupled to them. The S-IF 204 is an example of the interface units coupled to the storage system 100. Also, the host 200 may be a virtual machine.

The storage apparatus 100 comprises the first and the second file systems 242A and 242B, and a storage control unit which performs a write process or a read process of the file by corresponding to a write request or a read request from the host 200. Specifically, the storage apparatus 100 comprises one or more nodes 211 and a disk array apparatus 240 which is coupled to the one or more nodes 211.

The node 211 is an apparatus which converts a write request or a read request of a file from the host 200 to a write request or a read request of block data and sends the request to the disk array apparatus 240 (or transfers the write request or the read request of the file from the host 200 to the disk array apparatus 240). The node 211 is typically a computer. For example, the node 211 may be a server, and the host 200 may be a client. The node 211 comprises a frontend interface device (FE-I/F) 212 coupled to the host 200, a backend interface device (BE-I/F) 215 coupled to the disk array apparatus 240, a memory 213 and a processor 214 coupled to them. At least one node 211 may comprise a PDEV (for example a HDD) 216 coupled to the processor 214.

The disk array apparatus 240 comprises multiple PDEVs 241 which become the basis of multiple VOLs and multiple ports 231 coupled to one or more nodes 211 and comprises a controller (“CTL” in the drawing) 230 coupled to the multiple PDEVs 241. The port 231 receives a write request or a read request from the nodes 211. The controller 230 performs write or read to/from the VOL corresponding to the write request or the read request which the port 231 received. The controller 230 may comprise other than the ports 231, an interface device (D-IF) 234 coupled to the PDEV 241, a memory 233 and a processor 232 coupled to them. The controller 230 may be redundant such as the CTL0 and the CTL1. In the multiple VOLs, the VOL as the first file system 242A and the VOL as the second file system 242B are included.

The storage apparatus 100 may be so-called the converged storage, and communication within the nodes 211, and communication between the nodes 211 and the disk array apparatus 240 may be performed with the protocol of PCIe (PCI-Express). The communication between the nodes 211 and the disk array apparatus 240 may be performed with other protocols such as FC (Fibre Channel) instead of the PCIe. The BE-I/F 215 may be a host bus adapter and the port 231 may be a FC port. Also, the storage control unit may be configured with one or more nodes 211, and may include the controller 230 in addition to the one or more nodes 211. In addition, the storage control unit may comprise a frontend interface unit coupled to the host 200 and a backend interface unit coupled to multiple PDEVs 241. The frontend interface unit may be configured with one or more FE-I/Fs 212 of one or more nodes 211. The backend interface unit may be configured with one or more BE-I/Fs 215 of one or more nodes 211, or may be configured with a D-I/F 234 of the controller 230. Also, the backend interface unit may be configured, without having the node 211, but with the disk array apparatus 240 coupled to the host 200, and the function of the node 211 is provided with the controller 230. In addition, the first and the second file systems 242A and 242B may exist in different storage apparatuses 100 in a case where the storage system comprises multiple storage apparatuses 100. Multiple hosts 200 may exist and the first file system 242A may exist in each of the hosts 200, and the second file system 242B may be common to multiple hosts 200 (multiple first file systems 242A). Also, at least one of the first and the second file systems 242A and 242B may be based on at least one of storage resources (for example, a memory) out of the node 211 and the controller 230 instead of the PDEV 241.

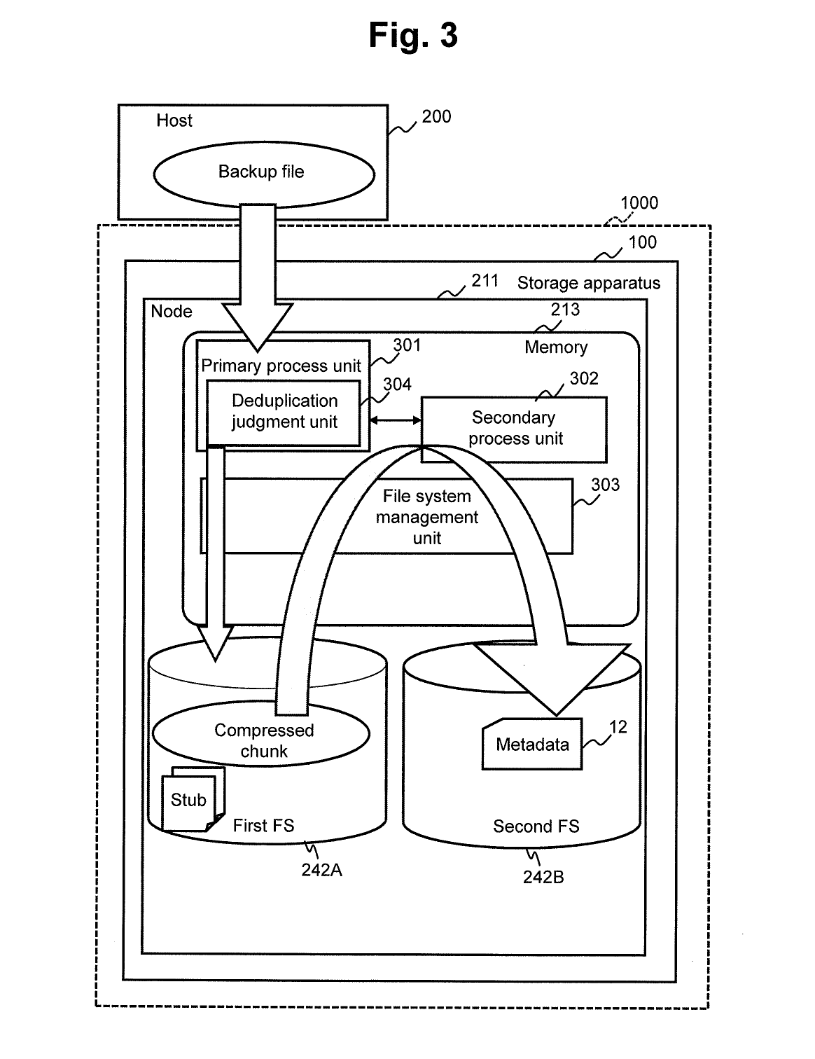

FIG. 3 is a block diagram to show the function of a storage system according to Embodiment 1.

The node 211 comprises a primary process unit 301, a secondary process unit 302 and a file system management unit 203. The primary process unit 301, the secondary process unit 302 and the file system management unit 203 may be respectively functions realized by the processor 214 which executes a primary process program, a secondary process program and a file system management program. At least a part of each of the primary process unit 301, the secondary process unit 302 and the file system management unit 203 may be realized by an specialized hardware.

The primary process unit 301 performs S11 through S13 which are shown in FIG. 1. The primary process unit 301 comprises a deduplication judgment unit 304 and the deduplication judgment unit 304 performs the deduplication judgment on S13. The primary process unit 301 and the secondary process unit 302 communicate each other. The secondary process unit 302 performs the deduplication process such as S14 (the synchronous deduplication process) and S21 (the asynchronous deduplication process). A file system management unit 303 is the interface to the first and the second file systems 242A and 242B. The primary process unit 301 is to access to the first file system 242A via the file system management unit 303 and the secondary process unit 302 is to access to the first and the second file systems 242A and 242B via the file system management unit 303.

Specifically, the primary process unit 301 receives a backup file (hereinafter, referred to as a file) from the host 200, and performs a deduplication judgment at the deduplication judgment unit 304. In a case where the judgment result is true, the primary process unit 301 makes the secondary process unit 302 perform the deduplication process, and the compressed chunk without having duplication is written to the second file system 242B via the file system management 303 by the secondary process unit 302. On the other hand, in a case where the judgment result is false, the primary process unit 301 writes the compressed chunk to the first file system 242A via the file system management unit 303. Thereby, the compressed chunk which the deduplication process has not been performed exists in the first file system 242A. The secondary process unit 302 reads the compressed chunk from the first file system 242A in the asynchronous deduplication process, and performs the duplication judgment on whether or not a compressed chunk which duplicates the compressed chunk read from the first file system 242A exists in the second file system 242B, and in a case where the duplication judgment result is false, the secondary process unit 302 writes the compressed chunk to a metadata 12 in the second file system 242B. The metadata 12 is an example of the management data of the compressed chunk which the deduplication process has been performed (details will be described further below). In a case where the deduplication process has been performed on all of the compressed chunks which configure the file, a stub file of the file is created by the secondary process unit 302 and the stub file is stored in the first file system 242A via the file system management unit 303.

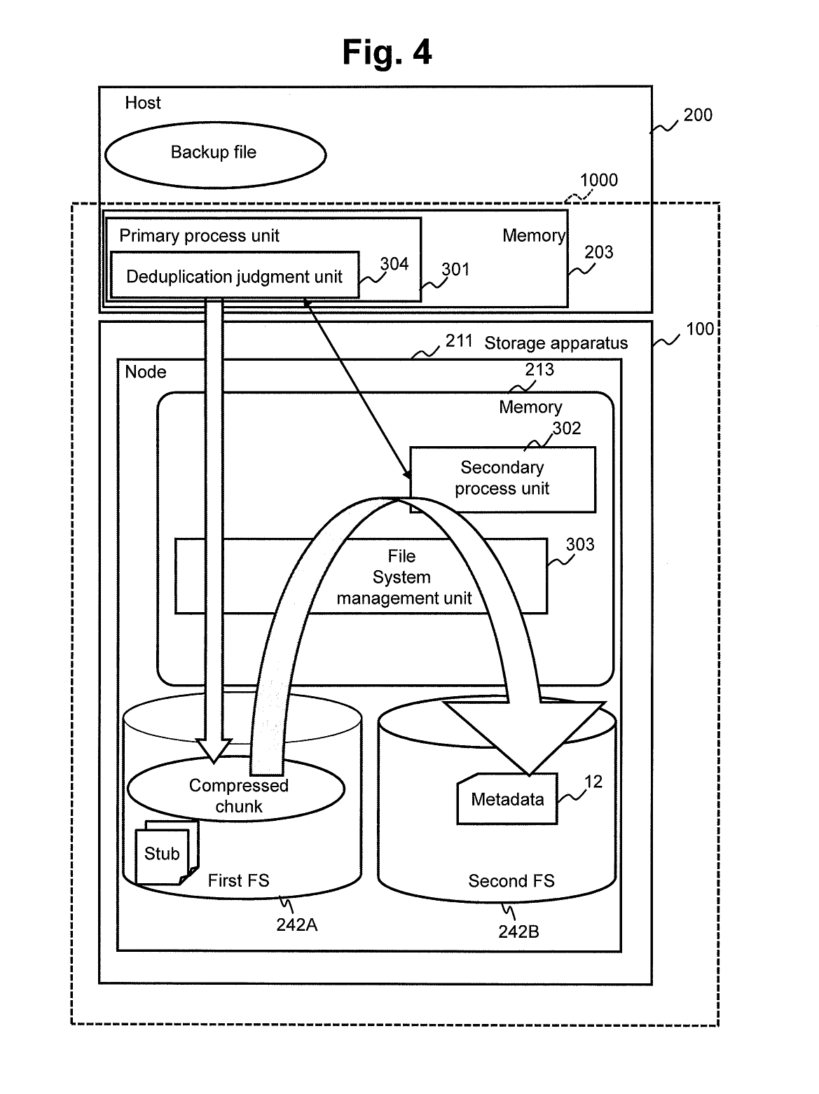

The control unit of the storage system may comprise the primary process unit 301, the secondary process unit 302 and the file system management unit 303. The primary process unit 301 and the secondary process unit 302 may be united. Also, as shown in FIG. 4, the primary process unit 301 may exist not in the storage apparatus 100 but in the host 200. Thereby, the load to the storage apparatus 100 can be reduced. Also, in a case where the storage system comprises multiple storage apparatuses 100, the primary process unit 301 and the secondary process unit 302 may exist in different storage apparatuses 100 or may exist in the same storage apparatus 100. Instead of the host 200, one or more storage apparatuses 100 comprise both the primary process unit 301 and the secondary process unit 302, and by doing so, it is not necessary to add the primary process unit 301 to each of the hosts 200.

In addition, the secondary process unit 302 may regularly start an asynchronous deduplication process or may start when a predetermined start condition is satisfied. The predetermined start condition may be a condition that a free capacity of the first file system 242A became less than a predetermined capacity, or that a load of the processor (for example, a usage rate of the processor) which execute the secondary process unit 302 became less than a predetermined load. Also, the secondary process unit 302 may end the asynchronous deduplication process when the secondary process unit 302 performed the deduplication process on at least one compressed chunk (for example, all the compressed chunks) in the first file system 242A, or may end when a predetermined termination condition is satisfied. The predetermined termination condition may be that the free capacity of the first file system 242A becomes equal to or more than the predetermined capacity, or that the load of the processor which execute the secondary process unit 302 becomes equal to or more than the predetermined load.

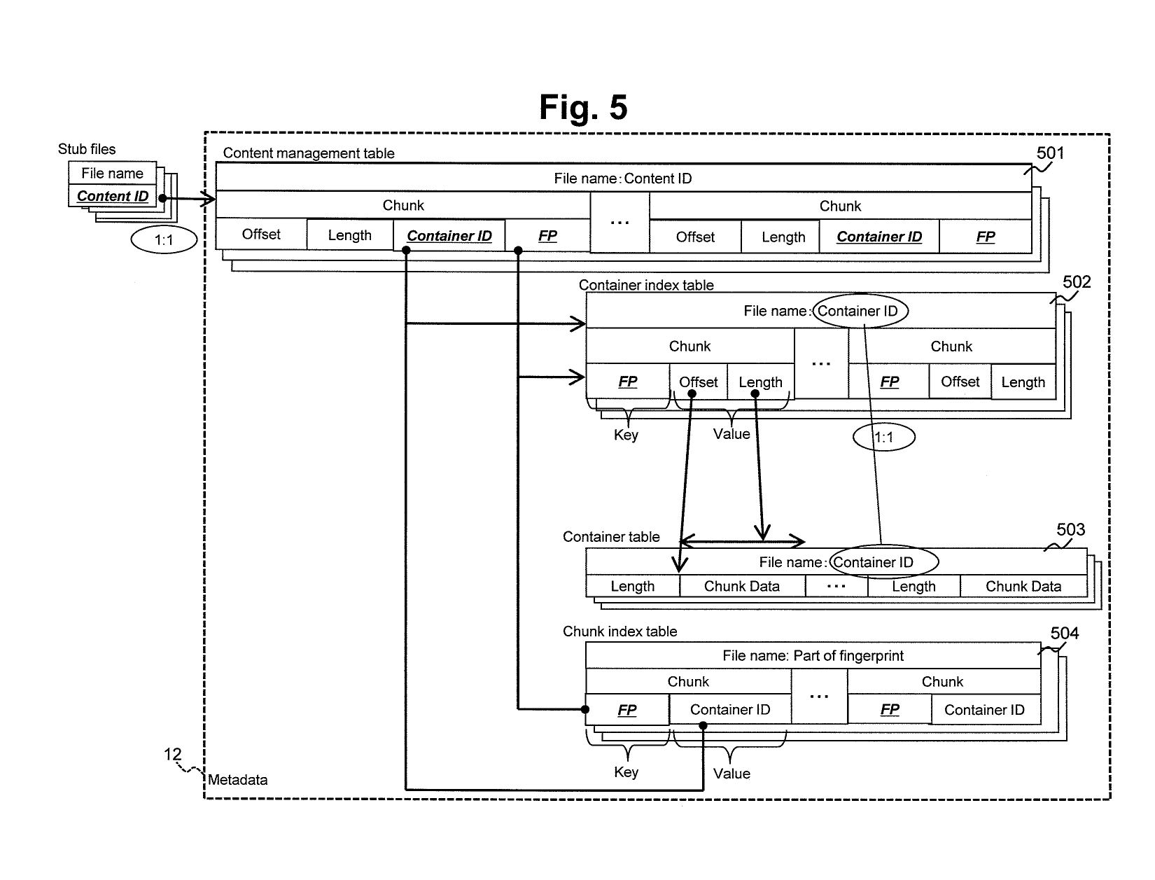

FIG. 5 shows a configuration of a metadata 12

The metadata 12 includes the compressed chunk itself which was judged being not duplicated. By referring to the metadata 12 using the compressed chunk of comparison target, it can be judged whether or not a compressed chunk which duplicates the compressed chunk of comparison target exists in the second file system 242B.

Specifically, the metadata 12 includes a content management table 501, a container index table 502, a container table 503 and a chunk index table 504. With respect to the metadata 12, “content” means the file, “chunk” means the chunk or the compressed chunk described above and “container” means a set of the multiple chunks (or the multiple compressed chunks).

The content management table 501 is the table associated with the stub file on one-to-one basis. The stub file corresponds to the file on one-to-one basis. The content ID which was created by the secondary process unit 302 as the identification information of the file which corresponds to the stub file is written to the stub file. The content management table 501 comprises the same content ID as the content ID which the stub file associated with the table 501 comprises as, for example, the file name of the table 501. Also, the content management table 501 includes an offset (a difference from the initial address of file till the initial address of chunk), a length (a size of a chunk), a container ID (a container ID including chunks) and a finger print (a hash value of a chunk (“FP” in the drawing)), for each of the chunks which configure the file corresponding to the table 501. The finger print is an example of data which denotes the characteristics of a chunk.

The container index table 502 exists for each of the containers. The container index table 502 comprises a container ID which is the identification information of the container corresponding to the table 502 as, for example, the file name of the table 502. Also, the container index table 502 includes a fingerprint (a fingerprint of a chunk), an offset (a difference from the initial address of a container table corresponding to the table 502 till the initial address of a chunk data) and a length (a length of a chunk data) for each of the chunks which configure the container corresponding to the table 502.

The container table 503 exists for each of the containers. Therefore, the container index table 502 and the container table 503 correspond on one-to-one basis. The container table 503 comprises a container ID which is the identification information of the container which corresponds to the table 503 as, for example, the file name of the table 503. Also, the container table 503 comprises a length (a size of a chunk data) and a chunk data (a compressed chunk itself) for each of the chunks which configure the container corresponding to the table 503. The length (the size of a chunk data) may not be necessary.

The chunk index table 504 includes, with respect to each of the predetermined number of the chunks, the finger print (the fingerprint of the chunk) and the container ID (the container ID for the container including the chunk). The chunk index table 504 comprises, for example, a part of at least one fingerprint (for example, the head of a fingerprint) which the table 504 includes as the file name.

With respect to these using method and updating method on the meta-date 12, it will be explained further below. In addition, writing and reading to/from at least one of the first and the second file systems 242A and 242B (or, the PDEVs which are the basis of at least one of the first and the second file systems 242A and 242B) may be performed by a compressed chunk unit, or by a container unit which is configured with multiple compressed chunks. For example, in a case where the unit size of reading or writing to/from the PDEV is larger than the compressed chunk, and also the size of the container is a multiple of the unit size of reading or writing to/from the PDEVs, the reading or the writing may be performed by a container unit.

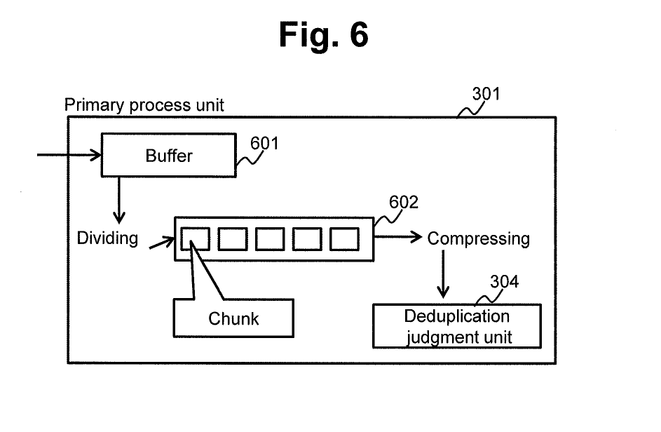

FIG. 6 is a schematic diagram for the function of a primary process unit 301.

The primary process unit 301 manages the area used as a buffer 601 and the area used as a queue 602, in the memory 213 of the node 211. The buffer 601 is the area in which a file is temporarily stored. The file read from the buffer 601 is removed from the buffer 601. The queue 602 is the area in which a chunk is temporarily stored. The chunk read from the queue 602 is removed from the queue 602. The queue 602, for example, may be the queue of FIFO (First in First out) format. The buffer 601 may exist for each of the hosts 200 and the queue 602 may exist for each of the files.

The primary process unit 301 stores the file in the buffer 601. The primary process unit 301 reads the file from the buffer 601, and divides the read file into chunks and stores each of the chunks in the queue 602. The primary process unit 301 reads the chunk from the queue 602 and compresses the read chunk, and the deduplication process unit 304 performs the deduplication judgment with respect to the compressed chunk (the chunk having been compressed).

Hereinbelow, the processes performed in Embodiment 1 will be explained in details.

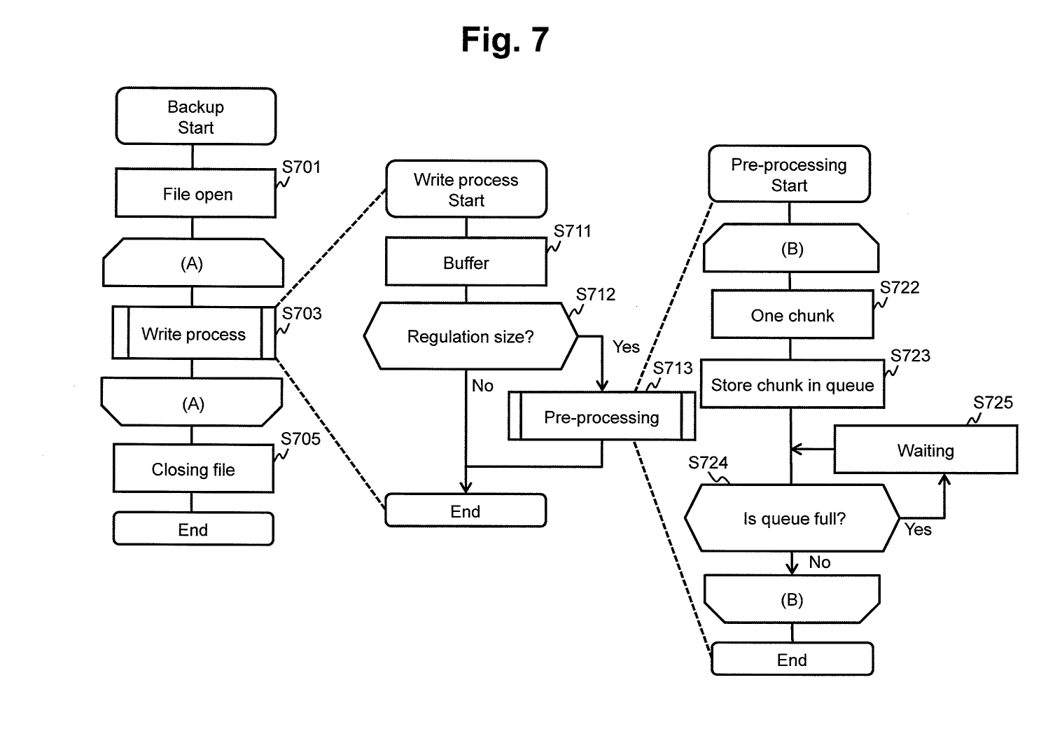

FIG. 7 shows a flow of a file backup process.

The open of a write destination of the file is performed (S701). The write process (S703) for the size of the file (Loop (A)) is performed, and the closing of the write destination is performed (S705) thereafter. In S705, the write completion is informed to the host 200 from the storage apparatus 100.

In the write process (S703) of the file, the primary process unit 301 stores the file in the buffer 601 (S711). If the total size of one or more files in the buffer 601 becomes equal to or more than the predetermined size (the regulation size) in accordance with S711 (S712:Yes), the primary process unit 301 performs a pre-processing (S713), but if the total size remains less than the predetermined size (S712:No), the primary process unit 301 ends the write process (S703).

In the pre-processing of the file (S713), the primary process unit 301 performs S722 through S725 for the size of the predetermined size (Loop (B)). That is, the primary process unit 301 cuts out one chunk from the file in the buffer 601 (S722) and stores the cut out chunk in the queue 602 (S723). In a case where the queue 602 is full (S724:Yes), the primary process unit 301 waits (S725) and, in a case where the queue 602 is not full (S724:No), exits from the Loop (B) if the total size of the cut out chunks is equal to the size of the predetermined size, and performs S722 if the total size of the cut out chunks is less than the predetermined size.

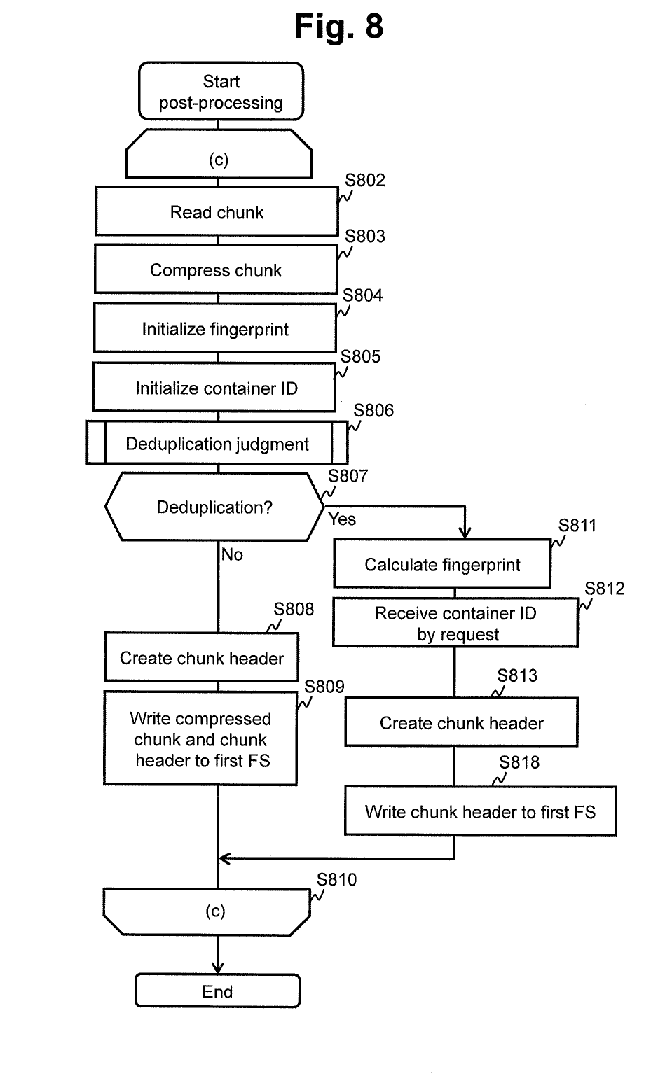

FIG. 8 shows a flow of a post-processing.

The post-processing starts when a chunk was stored in the queue 602. S802 through S813 is performed until the queue 602 becomes empty (Loop (C)).

The primary process unit 301 reads a chunk from the queue 602 (S802) and compresses the read chunk (S803). The primary process unit 301 initializes the fingerprint (S804) and also initializes the container ID (S805) with respect to the compressed chunk. The initialization of the fingerprint and the container ID may be, for example, to respectively assign the initial values to the variable of the fingerprint and the variable of the container ID. The primary process unit 301 performs the deduplication judgment with respect to the compressed chunk at the deduplication judgment unit 304 (S806).

The primary process unit 301, in a case where the result of the deduplication judgment on S806 is “not to perform deduplication” (S807:No), creates a chunk header of the compressed chunk (S808) and writes the compressed chunk and the chunk header to the first file system 242A (S809). The deduplication flag in the chunk header denotes the deduplication unprocessed.

On the other hand, the primary process unit 301 calculates a fingerprint of the compressed chunk (S810) in a case where the result of the deduplication judgment of S806 is “to perform deduplication” (S807:Yes). And, the primary process unit 301 sends a deduplication request including the compressed chunk and the calculated fingerprint to the secondary process unit 302, and by responding to the request, receives the container ID as the result of the deduplication process from the secondary process unit 302 (S811). The primary process unit 301 creates a chunk header (S812), and writes the created chunk header to the first file system 242A. The deduplication flag in the chunk header denotes the deduplication processed, and also the chunk header includes the fingerprint calculated in S810 and the container ID received in S811. The fingerprint and the container ID included in the chunk header are used when to perform the read of the file for which a stub file is not created. The read process of the files will be described in details hereinbelow.

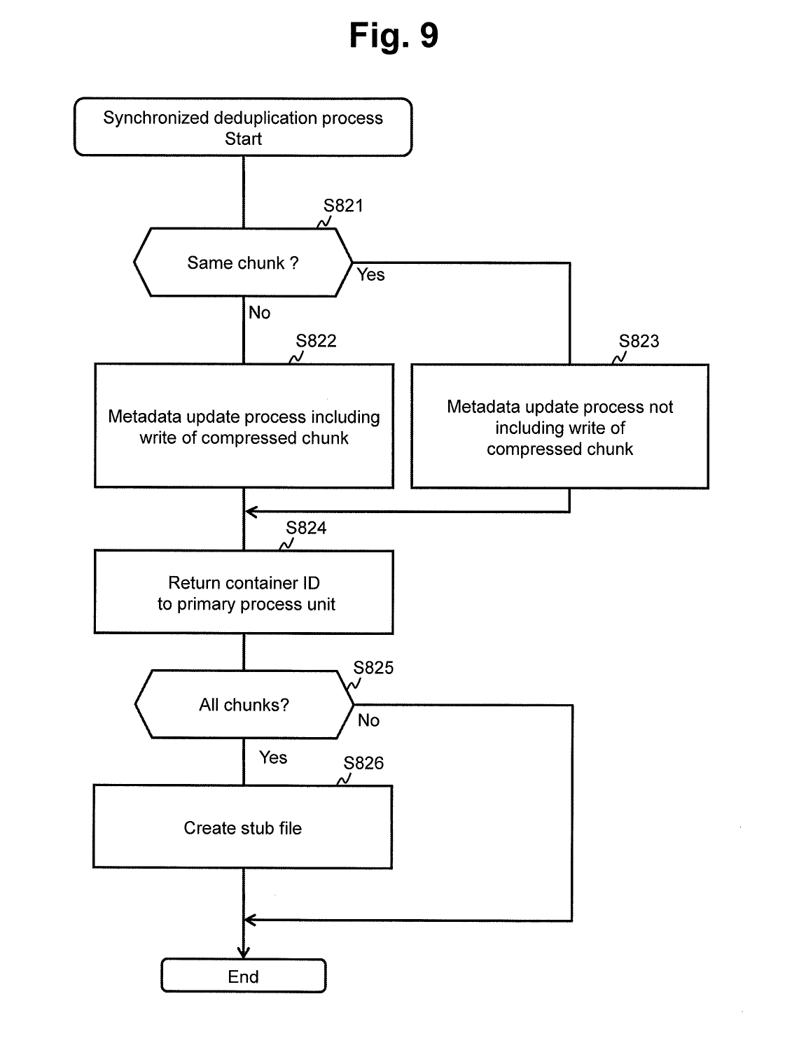

FIG. 9 shows a flow of a deduplication process.

A synchronized deduplication process starts in a case where the secondary process unit 302 received a deduplication request from the primary process unit 301. In addition, in the explanation on FIG. 9, the fingerprint which is in the process of the deduplication request is referred to as “the target fingerprint”, the compressed chunk which is in the process of the deduplication request is referred to as “the target compressed chunk”, the chunk which was decompressed from the target compressed chunk is referred to as “the target chunk” and the file which includes the target chunk is referred to as “the target file”.

The secondary process unit 302 searches the chunk index table 504 by using the target fingerprint as the key.

In a case where a fingerprint which matches the target finger print was not found from the chunk index table 504 (S821:No), that means a compressed chunk which duplicates the target compressed chunk does not exist in the second file system 242B. In this case, the secondary process unit 302 performs S822, that is, the secondary process unit 302 (1) writes the target compressed chunk to a free field of the container table 503 as a chunk data. (2) writes the target fingerprint, the target container ID (the container ID which the table 503 of the write destination of the target compressed chunk comprises), the target offset (the offset of the target chunk in the target file) and the target length (the size of the target chunk) to the content management table 501 corresponding to the target file, (3) writes the target fingerprint, the target offset (the offset which denotes the location of the target compressed chunk in the table 503 which comprises the target container ID) and the target length (the size of the target compressed chunk) to the container index table 502 which comprises the target container ID, and also (4) writes the pair of the target fingerprint and the target container ID to a free field of the chunk index table 504.

In a case where a fingerprint which match the target finger print was found from the chunk index table 504 (S821:Yes), that means a compressed chunk which duplicates the target compressed chunk exists in the second file system 242B. In this case, the secondary process unit 302 performs S823, that is the secondary process unit 302 (1) identifies the container ID (the container ID which is being a pair with a fingerprint that matches the target fingerprint in the table 504), and also (2) writes the target fingerprint, the target container ID, the target offset (the offset of the target chunk in the target file) and the target length (the size of the target chunk) to the content management table 501 corresponding to the target file.

After S822 or S823, the secondary process unit 302 returns the target container ID in the processes to the primary process unit 301 as the result of the deduplication process (S824). The secondary process unit 302 judges whether or not the deduplication process has been performed or not with respect to all the chunks which configure the target file based on the content management table 501 corresponding to the target file (S825). In a case where the judgment result on S825 is true (S825:Yes), the secondary process unit 302 creates a stub file of the target file and writes the content ID to the stub file, and also writes the content ID to the content management table 501 corresponding to the target file (S826).

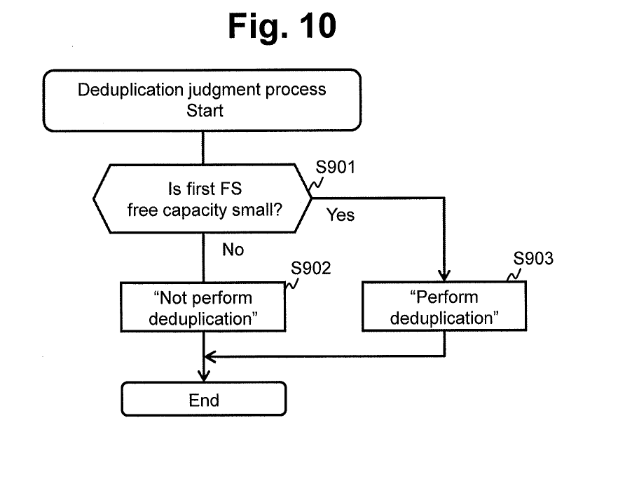

FIG. 10 shows a flow of a deduplication judgment according to Embodiment 1. The process flow shown in FIG. 10 is an example of S806 in FIG. 8.

The primary process unit 301 judges whether or not the free capacity of the first file system 242A is less than the predetermined capacity (S901). The primary process unit 301 decides “not to perform deduplication” (S902), in a case where the judgment result on S901 is false (S901:No), and decides “to perform a deduplication process” (S903), in a case where the judgment result on S901 is true (S901:Yes).

The first file system 242A assumes a role such as a cache area of compressed chunks, and also it takes more time to perform the deduplication process compared to the write of a compressed chunk to the first file system 242A. For this reason, the first file system 242A does not perform the synchronous deduplication process but writes the compressed chunk to the first file system 242A in a case where the free capacity of the first file system 242A is large, and in doing so, it is expected to realize both the shortening of the time of the write process and the improvement of the deduplication process rate in good balance. That is, the first file system 242A is effectively used in selecting whether or not to perform the synchronous deduplication process for the compressed chunk.

Also, the free capacity of first file system 242A is the capacity which can be variable corresponding to the progress of the write process and the process of FIG. 10 (S806 of FIG. 8) is performed for each of the compressed chunks which were read from the queue 602. For this reason, it is expected furthermore to realize both the shortening of the write process time and the improvement of the deduplication rate in good balance.

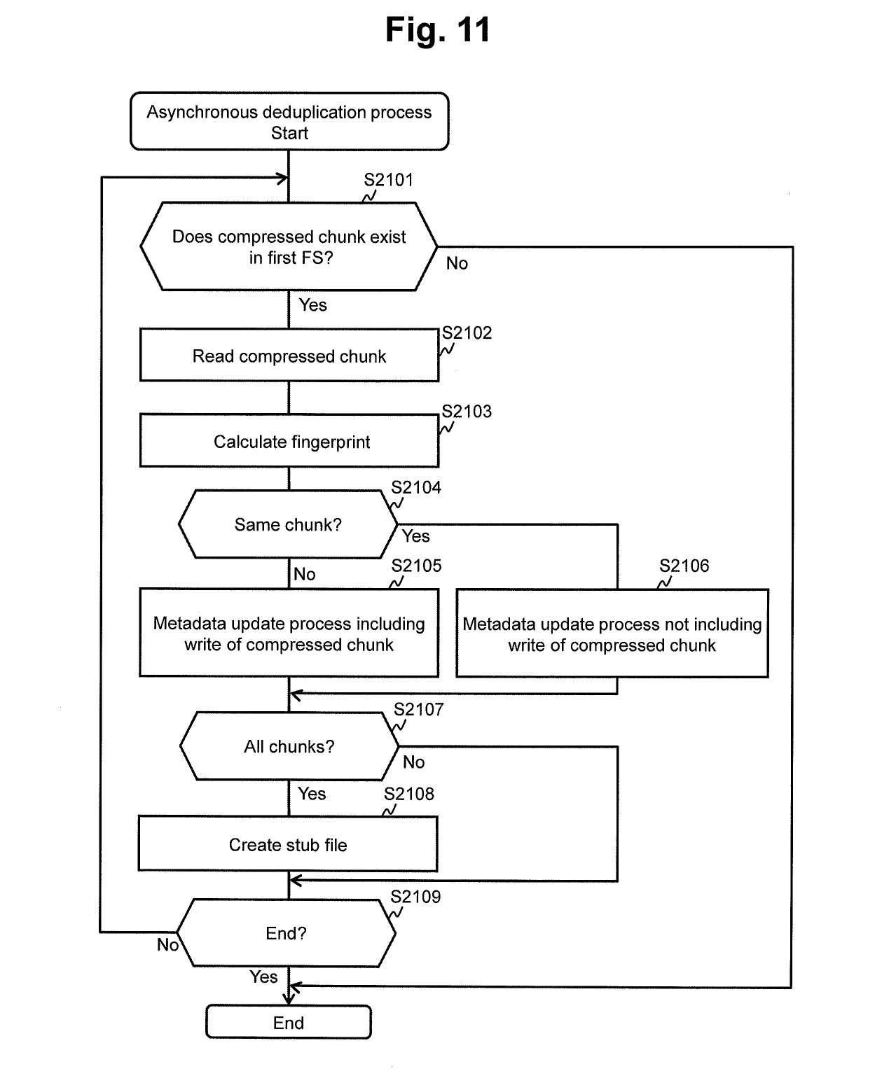

FIG. 11 shows a flow of an asynchronous deduplication process.

The asynchronous deduplication process, as described hereinabove, may start regularly or may start when a predetermined start condition is satisfied.

The secondary process unit 302 judges whether or not a compressed chunk exists in the first file system 242A (S2101). Specifically, for example, the secondary process unit 302 judges whether or not a chunk header including a deduplication flag which denotes the deduplication unprocessed exists in the first file system 242A.

In a case where the judgment result on S2101 is true (S2101:Yes), the secondary process unit 302 reads the compressed chunk from the first file system 242A (S2101), and calculate a fingerprint of the read compressed chunk (S2103). Hereinbelow, in the explanation in FIG. 11, the calculated fingerprint is referred to as “the target fingerprint”, the read compressed chunk is referred to as “the target compressed chunk”, the chunk which was decompressed from the target compressed chunk is referred to as “the target chunk” and the file including the target chunk is referred to as “the target file”.

The secondary process unit 302 searches the chunk index table 504 by using the target finger print as the key (S2104). In a case where a fingerprint which matches the target fingerprint was not found from the chunk index table 504 (S2104:No), the secondary process unit 302 performs the same process as S822 in FIG. 9 (S2105). On the other hand, in a case where a fingerprint which matches the target fingerprint was found from the chunk index table 504, the secondary process unit 302 performs the same process as S823 in FIG. 9 (S2106). In S2105 or S2106, the secondary process unit 302 removes the target compressed chunks from the first file system 242A.

The secondary process unit 302 judges whether or not the deduplication has been processed or not on all the chunks which configure the target file based on the content management table 501 which corresponds to the target file (S2107). In a case where the judgment result on S2107 is true (S2107:Yes), the secondary process unit 302 performs the same process as S826 in FIG. 9 (S2108).

The secondary process unit 302 judges whether or not to end the asynchronous deduplication process (S2109). For example, the secondary process unit 302 may judge whether or not the deduplication process has been performed for the predetermined number of compressed chunks (for example, all the compressed chunks in the first file system 242A), or may judge whether or not the predetermined ending condition was satisfied. In a case where the judgment result on S2109 is true (S2109:Yes), the asynchronous deduplication process will end, and in a case where the judgment result on S2109 is false (S2109:No), S2101 is performed.

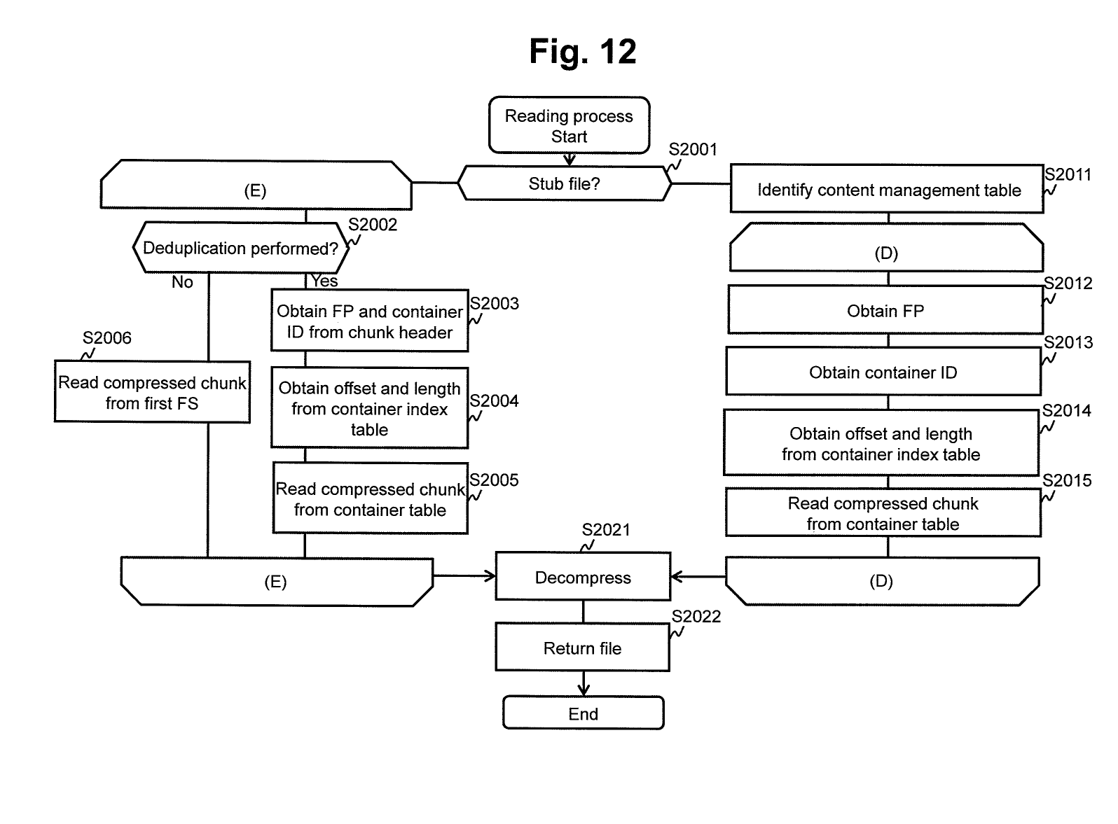

FIG. 12 shows a flow of a read process of a file.

The read process starts in a case where the storage apparatus 100 received a read request of the file from the host 200.

The file system management unit 303 judges whether or not the file which specified by the read request is a stub file (S2001).

In a case where the judgment result on S2001 is true (S2001:Yes), the file system management unit 303 restores the file corresponding to the stub file as follows. The file system management unit 303 identifies the content management table 501 which comprises the content ID corresponding to the content ID in the stub file (S2011). The file system management unit 303 refers to the identified content management table 501 and performs the following processes on each of the compressed chunks (Loop (D). That is, the file system management unit 303 obtains the container ID and the fingerprint corresponding to the compressed chunk from the identified table 501 (S2012 and S2013), identifies the offset and the length from the container index table 502 which comprises the obtained container ID and the fingerprint (S2014), and reads data of which the length is equal to the length identified in S2014 from the location of the offset identified in S2014 in the container table 503 which comprises the obtained container ID (S2015). The read data is the compressed chunk (the chunk data) in the container table 503. The read compressed chunk is stored by the file system management unit 303 in the memory (for example the cache area) 213 of the node 211 which executes the management unit 303. S2012 through S2015 are performed for each of the compressed chunks which correspond to the stub file, and in doing so, all the compressed chunks corresponding to the stub file is stored in the memory 213. The file system management unit 303 restores the original file of the stub file by decompressing each of the compressed chunks (S2021), and sends the restored file to the host 200 which is the sending source of the read request (S2022).

In a case where the judgment result on S2001 is false (S2001:No), the file system management unit 303 restores the file as follows. The file system management unit 303 performs the following processes for each of the compressed chunks corresponding to the file (Loop (E)). That is, the file system management unit 303 judges whether or not the deduplication has been processed with respect to the compressed chunk based on whether the deduplication flag in the chunk header of the compressed chunk denotes the deduplication processed or unprocessed (S2002). In a case where the judgment result on S2002 is true (S2002;Yes), the file system management unit 303 obtains the fingerprint and the container ID from the chunk header (S2003), and performs the same processes as S2014 and S2015 by using the fingerprint and the container ID (S2004 and S2005). On the other hand, in a case where the judgment result on S2002 is false (S2002;No), the file system management unit 303 reads the compressed chunk corresponding to the chunk header from the first file system 242A (S2006). The read compressed chunk is stored in the memory 213. S2002 through S2006 are performed for each of the compressed chunks corresponding to the file, and in doing so, all the compressed chunks corresponding to the file are stored in the memory 213. The file system management unit 303 restores the file by decompressing each of the compressed chunks (S2021) and sends the restored file to the host 200 which is the sending source of the file (S2022).

### Embodiment 2

Hereinbelow, Embodiment 2 will be explained. In so doing, the points of difference with Embodiment 1 will mainly be explained, and the explanations of the points in common with Embodiment 1 will be omitted or simplified.

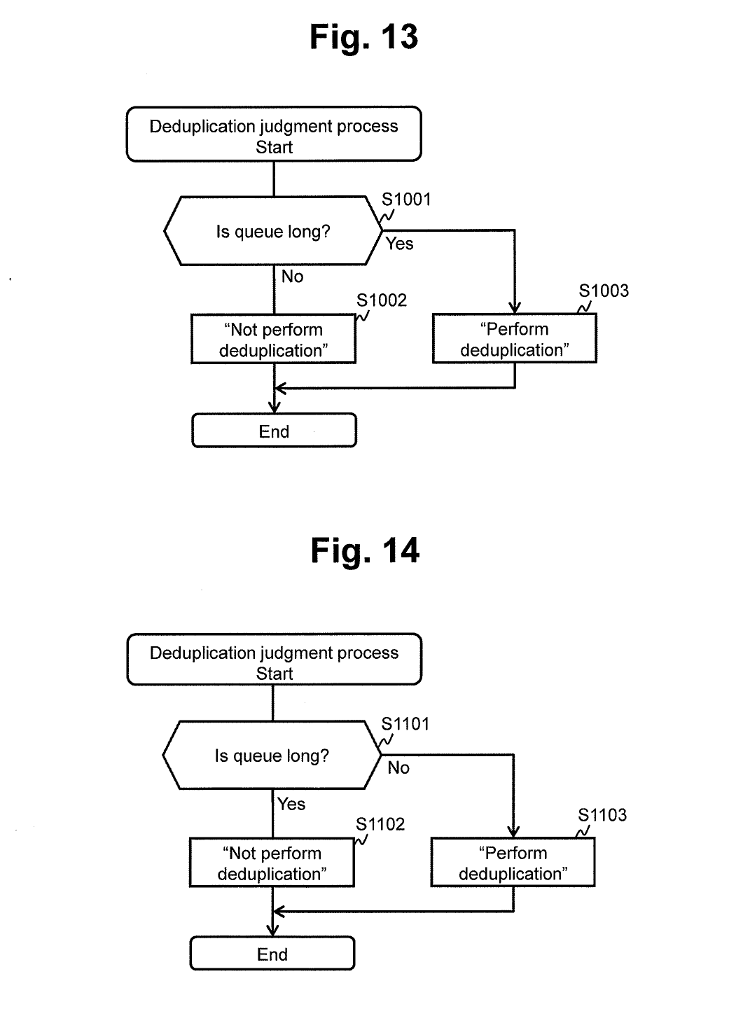

FIG. 13 shows a flow of a deduplication judgment according to Embodiment 2. The process flow shown in FIG. 13 is an example of S806 of FIG. 8.

The primary process unit 301 judges whether or not the queue 602 is long (the unprocessed chunk number which is the number of chunks stored in the queue 602 is equal to or more than the predetermined number) (S1001). The primary process unit 301 decides “not to perform deduplication” (S1002), in a case where the judgment result on S1001 is false (S1001:No), and decides “to perform deduplication” (S1003), in a case where the judgment result on S1001 is true (S1001:Yes).

In a case where the queue 602 is long, it is considered that the write to the first file system 242A is slow, or the write to the buffer 601 is fast (for example, the process of the host 200 is too fast). In this case, if the decision “to perform deduplication” with respect to the compressed chunk of comparison target is made, it can be expected to shorten the time required for the write process since the frequency of write to the first file system 242A is reduced. Also, in a case where the process of the host 200 is too fast, it can be expected to slow down the process of the host 200 by making the host 200 calculate fingerprints of the compressed chunks.

In addition, the length of the queue 602 can be variable corresponding to the progress of the write process, and the process in FIG. 13 (S806 of FIG. 8) is performed for each of the compressed chunks which are read from the queue 602. For this reason, it can be expected furthermore to realize both the shortening of the write process time and the improvement of the deduplication rate in good balance.

### Embodiment 3

Hereinbelow, Embodiment 3 will be explained. In so doing, the points of difference with Embodiment 1 will mainly be explained, and the explanations of the points in common with Embodiment 1 will be omitted or simplified.

FIG. 14 shows a flow of a deduplication judgment according to Embodiment 3. The process flow shown in FIG. 14 is an example of S806 of FIG. 8.

The primary process unit 301 judges whether or not the queue 602 is long (the unprocessed chunk number which is the number of chunks stored in the queue 602 is equal to or more than the predetermined number) (S1101). The primary process unit 301 decides “not to perform deduplication” (S1102), in a case where the judgment result on S1101 is true (S1101:Yes), and decides “to perform deduplication” (S1103), in a case where the judgment result on S1101 is false (S1101:No).

In accordance with Embodiment 3, the synchronous deduplication process is performed in a case where the queue 602 is short. One of the causes that the queue 602 is short is considered that the load of the storage apparatus 100 is low, and in this case, it can be expected to maintain the speed of the synchronous deduplication process above a certain speed level.

Also, the length of the queue 602 can be variable corresponding to the progress of the write process, and the process in FIG. 14 (S806 of FIG. 8) is performed for each of the compressed chunks which are read from the queue 602. For this reason, it can be expected furthermore to realize both the shortening of the write process time and the improvement of the deduplication rate in good balance.

### Embodiment 4

Hereinbelow, Embodiment 4 will be explained. Embodiment 4 is equivalent to a combination of Embodiment 1 and Embodiment 2. Hereinbelow, the points of difference with Embodiment 1 and Embodiment 2 will mainly be explained, and the explanations of the points in common with Embodiment 1 and Embodiment 2 will be omitted or simplified.

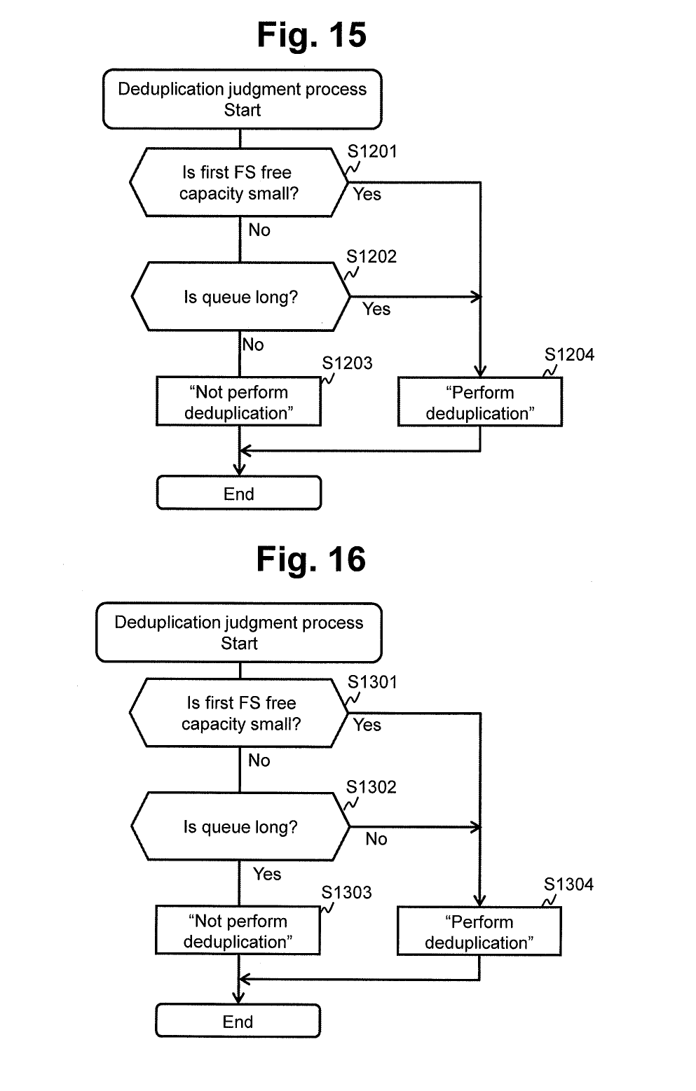

FIG. 15 shows a flow of a deduplication judgment according to Embodiment 4. The process flow shown in FIG. 15 is an example of S806 in FIG. 8.

The primary process unit 301 judges whether or not the free capacity of the first file system 242A is less than the predetermined capacity (S1201). The primary process unit 301 decide “to perform deduplication” (S1204), in a case where the judgment result on S1201 is true (S1201:Yes)

The primary process unit 301 judges whether or not the queue 602 is long (S1202), in a case where the judgment result on S1201 is false (S1201:No). The primary process unit 301 decides “not to perform deduplication” (S1203), in a case where the judgment result on S1202 is false (S1202:No), and decides “to perform deduplication” (S1204), in a case where the judgment result on S1202 is true (S1202:Yes). That is, the decision “to perform deduplication” is made if the queue 602 is long even though the free capacity of the first file system 242A is small.

In accordance with Embodiment 4, the first file system 242A can be effectively used in selecting whether or not to perform a synchronous deduplication process for a compressed chunk, and also it can be expected that the time required for a write process becomes shorter. In addition, in Embodiment 4, the priority is set higher on the free capacity of the first file system 242A than on the length of the queue 602. This is because there is a risk that if the free capacity of the first file system 242A is completely filled by a certain file, the backup for other files becomes not possible (the host 200 becomes not able to send the file to the storage apparatus 100).

### Embodiment 5

Hereinbelow, Embodiment 5 will be explained. Embodiment 5 is equivalent to a combination of Embodiment 1 and Embodiment 3. Hereinbelow, the points of difference with Embodiment 4 will mainly be explained, and the explanations of the points in common with Embodiment 4 will be omitted or simplified.

FIG. 16 shows a flow of a deduplication judgment according to Embodiment 5. The process flow shown in FIG. 16 is an example of S806 in FIG. 8.

The primary process unit 301 judges whether or not the queue 602 is long (S1302), in a case where the judgment result on whether or not the free capacity of the first file system 242A is less than the predetermined capacity was false (S1301:No), however, in a case where the judgment result on S1302 is true (S1302:Yes), the primary process unit 301 decides “not to perform deduplication” (S1303), and in a case where the judgment result on S1302 is false (S1302:No), the primary process unit 301 decides “to perform deduplication” (S1304). That is, the decision “to perform deduplication” is made in a case where the free capacity of the first file system 242A is small and also the queue 602 is short.

In accordance with Embodiment 5, the first file system 242A can be effectively used in selecting whether or not to perform a synchronous deduplication process for the compressed chunk, and also it can be expected to maintain the speed of the synchronous deduplication process above a certain speed level.

### Embodiment 6

Hereinbelow, Embodiment 6 will be explained. In so doing, the points of difference with Embodiment 1 through 5 will mainly be explained, and the explanations of the points in common with Embodiment 1 through 5 will be omitted or simplified.

In Embodiment 6, the judgment on whether or not to perform a synchronous deduplication process of a compressed chunk is made on the basis of whether or not an attribute of the file satisfies a predetermined condition, in addition to or instead of a usage capacity such as at least one of a free capacity of the first file system 242A and a length of the queue 602. Hereinbelow, the judgment is referred to as “the strategy judgment”.

FIG. 17 shows a part of a file backup process according to Embodiment 6.

The strategy judgment is performed in a case where S701 in FIG. 7 is performed, namely the opening of the write destination of the file is performed (S1402), and the Loop (A) is started afterwards.

The result of the strategy judgment directly influence on performing a synchronous deduplication process for each of compressed chunks in the write process. That is, if the result of the strategy judgment is “not to perform deduplication”, the synchronous deduplication process with respect to all the compressed chunks corresponding to the file will not be performed, and if the result of the strategy judgment is “to perform deduplication”, the synchronous deduplication process with respect to all the compressed chunks corresponding to the file is performed. Thus, the processing load of the primary process unit 301 can be reduced by performing the strategy judgment (equivalent to the deduplication judgment) not by a compressed chunk unit but by a file unit which is larger unit than the compressed chunk.

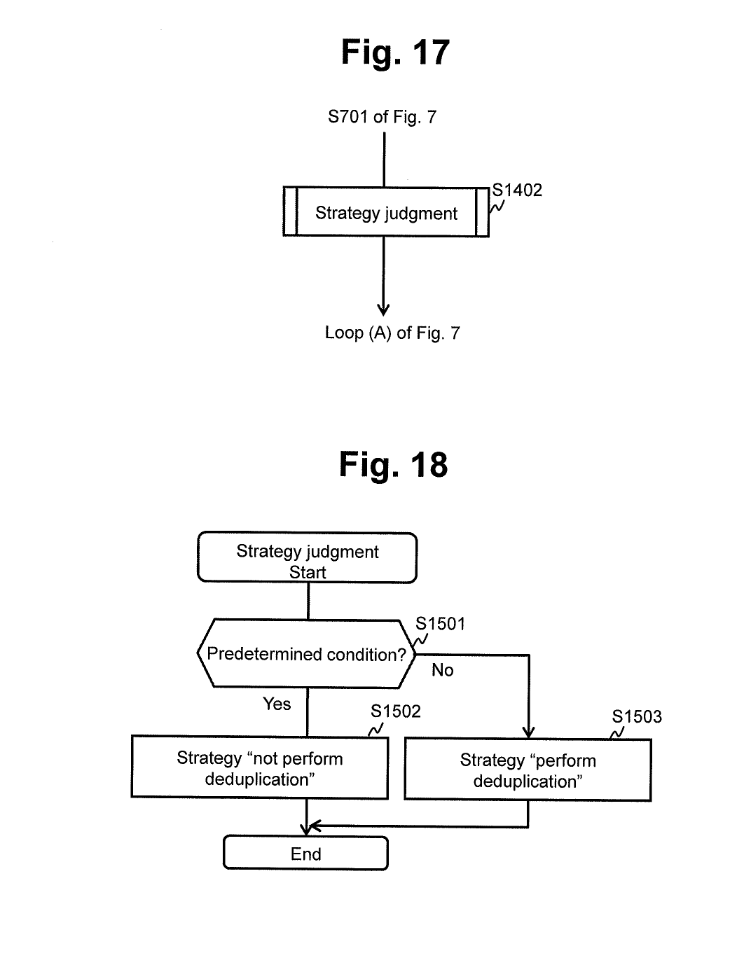

FIG. 18 shows a first example of strategy judgment.

The primary process unit 301 (or the file system management unit 303) judges whether or not the attribute of the file (the backup file) fits into the predetermined condition (S1501). In a case where the judgment result on S1501 is true (S1501:Yes), the primary process unit 301 (or the file system management unit 303) decides “not to perform deduplication” (S1502), and in a case where the judgment result on S1501 is false (S1501:No), the primary process unit 301 (or the file system management unit 303) decides “to perform deduplication” (S1503).

The meaning of “an attribute of a file meets a predetermined condition” may be that the file is to fit at least one kind of files among, for example, a compressed file (for example, a file with a file extension such as “gzip”, “bzip2”, “zip” or “cab”), a image file (for example, a file with a file extension such as “jpeg”, “png”, “gif” or “pdf”), a log file (for example, a file with a file extension such as “log”) and a dump file (for example, a file with a file extension such as “dmp”). These files are considered that the deduplication effect is low, and therefore, it is considered that making the decision of “not to perform deduplication” (a synchronous duplication process is not to be performed) is preferable, in a case where the file fit into any of these files. In accordance with this, it can be expected to avoid that the time used for a write process becomes wastefully longer. Also, the meaning of “an attribute of a file meets a predetermined condition” may be, for example, that the file fits to the backup file of the first generation. For example, it is considered to be preferable that the decision of “not to perform deduplication” is made on the backup file of the first generation of which the deduplication effect is low, and the decision of “to perform deduplication” is made on the backup files of the second generation or the further generations of which the deduplication effect is high. In accordance with this, it can be expected to realize both the shortening of the write process time and the improvement of the deduplication rate.

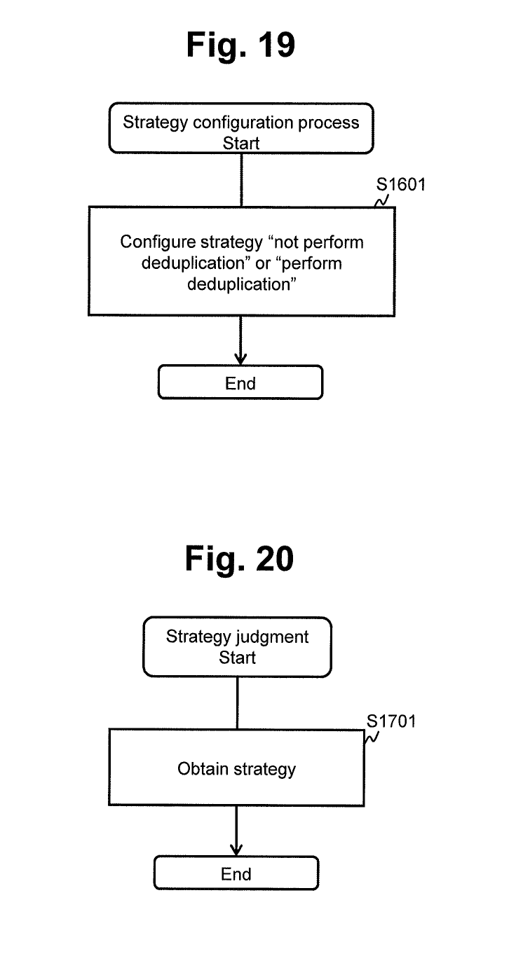

FIG. 19 shows a flow of a strategy configuration process.

The primary process unit 301 (or the file system management unit 303) configures the result of the strategy judgment (S1402) to the memory of the apparatus which executes the primary process unit 301 (S1601). The result of this is used for the judgment on S807 in FIG. 8.

In addition, in Embodiment 6, S806 is not necessary, but as the result of S807 (whether or not to perform deduplication), both the result of the strategy judgment and the result of the deduplication judgment on S806 may be used. For example, in a case where the result of the strategy judgment is “to perform deduplication” and the result of the deduplication judgment on S806 is also “to perform deduplication”, the state may become S807:Yes, and in a case where at least one of the results is “not to perform deduplication”, the state may become S807:No.

FIG. 20 shows a second example of strategy judgment.

The primary process unit 301 (or the file system management unit 303) obtains the strategy of “not to perform deduplication” or “to perform deduplication” from the information (for example, the information which denotes a policy) configured by the user (S1701). In addition, “the user” may be a user of the host 200 or may be a user (an administrator) of the management computer (no drawing) which manages at least one of the host 200 and the storage apparatus 100. The information configured by the user, for example, may be the information which denotes the corresponding relationship between the attribute of the file (for example, the file extension or the file name) and the strategy.

### Embodiment 7

Hereinbelow, Embodiment 7 will be explained. In so doing, the points of difference with Embodiment 1 through 6 will mainly be explained, and the explanations of the points in common with Embodiment 1 through 6 will be omitted or simplified.

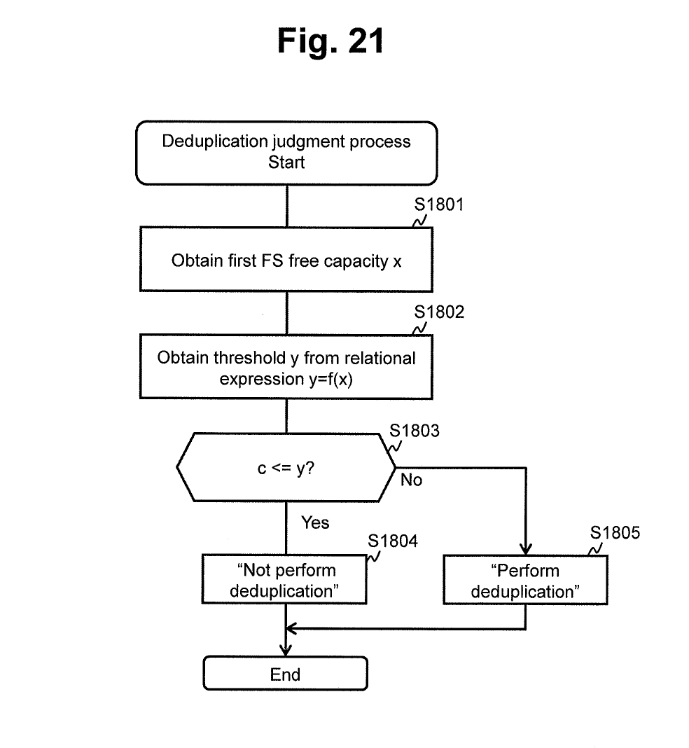

FIG. 21 shows a flow of a deduplication judgment according to Embodiment 7. The process flow shown in FIG. 21 is an example of S806 in FIG. 8.

The primary process unit 301 obtains the free capacity x from the first file system 242A (S1801). In addition, the unit of the free capacity may be the unit which denotes a size such as GB (gigabyte) or may be the unit which denotes a ratio such as % (percent).

The primary process unit 301 decides the threshold y based on the free capacity of the file system 242A x. Specifically, for example, the primary process unit 301 obtains the threshold y from the relational expression y=f(x) (S1802).

The primary process unit 301 judges whether or not the compression rate of the compressed chunk c is less than the threshold y (S1803). The compression rate c is “the size of the compressed chunk”/“the size of the original chunk”. That is, the smaller the size of the compressed chunk is, the compression rate becomes smaller. Therefore, the compression rate c becomes less than the threshold y means that the compression effect is high.

In a case where the judgment result on S1803 is true (S1803:Yes), namely, in a case where the compression effect is high, the primary process unit 301 decides “not to perform deduplication” (S1804), and in a case where the judgment result on S1803 is false (S1803:No), namely, in a case where the compression effect is low, the primary process unit 301 decides “to perform deduplication” (S1805).

Since the size of the compressed chunk of which the compression effect is high is small, the degree to reduce the free capacity is small, even though the compressed chunk would be written to the first file system 242A. With respect to such compressed chunks, it can be expected to avoid the wasteful performance reduction and the wasteful capacity consumption in good balance by avoiding the asynchronous deduplication process.

### Embodiment 8

Hereinbelow, Embodiment 8 will be explained. In so doing, the points of difference with Embodiment 7 will mainly be explained, and the explanations of the points in common with Embodiment 7 will be omitted or simplified.

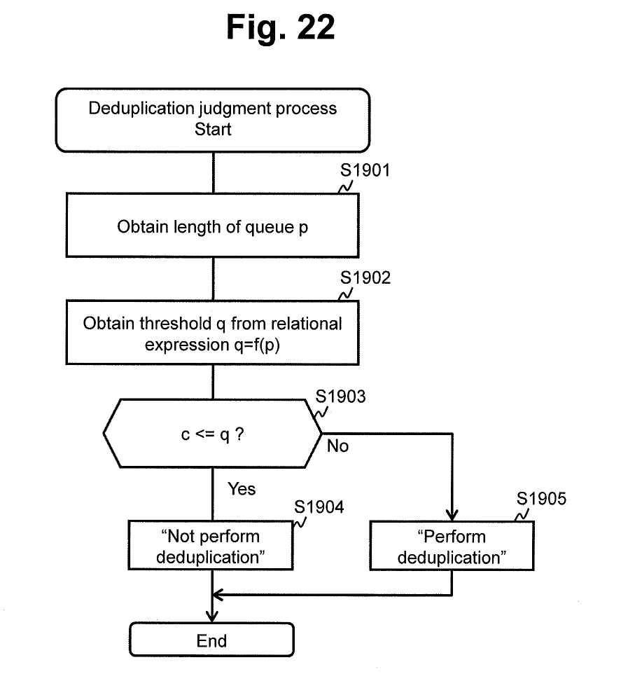

FIG. 22 shows a flow of a deduplication judgment according to Embodiment 8. The process flow shown in FIG. 22 is an example of S806 in FIG. 8.

The primary process unit 301 obtains the length of the queue 602 p (S1901). In addition, the unit of length of the queue 602 may be the unit which denotes a size such as B (byte) or may be a number of unprocessed chunks.

The primary process unit 301 decides the threshold q based on the length of queue 602 p. Specifically, for example, the primary process unit 301 obtains the threshold q from the relational expression q=f(p) (S1902).

Thereafter, the processes the same as S1803 through S1805 shown in FIG. 21 will be performed (S1903 through S1905).

As above, several embodiments are explained but the present invention is not limited to these embodiments. For example, the storage system is configured in order that any of Embodiment 1 through 8 can be performed, and the process to be performed according to any of the Embodiment among Embodiment 1 through 8 may be selected, based on the predetermined condition. The selection may be selected in any unit among a host unit, a file unit and a chunk unit.

### REFERENCE SIGNS LIST

100: Storage apparatus
200: Host apparatus

1. A storage system, comprising:
one or more storage areas; and
a control unit being configured to perform a write process of a file,
the control unit comprising a memory,
the control unit being configured to store the file in the memory in the write process, and with respect to each of multiple chunks composing the file,
read a chunk from the memory,
perform a deduplication process with respect to the chunk read from the memory, in a case where at least one of an attribute of the file and a load of the storage system at a time of the chunk being read from the memory satisfies a predetermined condition, control, in the deduplication process, whether or not to write the chunk read from the memory to a second storage area, based on whether or not a chunk duplicating the chunk read from the memory is stored in the second storage area which is one of storage areas among the one or more storage areas, and
write the chunk read from the memory to a first storage area which is a different storage area from the second storage area among the one or more storage areas, in a case where at least one of the attribute of the file and the load of the storage system does not satisfy the predetermined condition.

2. The storage system according to claim 1, wherein
the control unit is configured to judge, at each time of reading a chunk from the memory, whether or not the chunk satisfies the predetermined condition.

3. The storage system according to claim 2, wherein
the load of the storage system is a free capacity of the first storage area, and
the predetermined condition is that the free capacity of the first storage area is less than a predetermined capacity.

4. The storage system according to claim 2, wherein
the load of the storage system is a memory chunk number which is the number of chunks stored in the memory, and
the predetermined condition is that the memory chunk number is equal to or more than a predetermined number.

5. The storage system according to claim 2, wherein
the load of the storage system is a memory chunk number which is the number of chunks stored in the memory, and
the predetermined condition is that the memory chunk number is less than a predetermined number.

6. The storage system according to claim 2, wherein
the load of the storage system is a free capacity of the first storage area and a memory chunk number which is the number of chunks stored in the memory, and
the predetermined condition is that the free capacity of the first storage area is less than a predetermined capacity and the memory chunk number is less than a predetermined number.

7. (canceled)

8. The storage system according to claim 1, wherein
the control unit is configured to perform a condition judgment whether or not the attribute of the file satisfies a predetermined condition at file open, decide to perform the deduplication process with respect to the file, in a case where a result of the condition judgment is false, and decide not to perform the deduplication process with respect to the file, in a case where a result of the condition judgment is true,
the control unit is configured to control whether or not to perform the deduplication process, based on a decision according to a result of the condition judgment, with respect to chunks of the file.

9. The storage system according to claim 8, wherein
the predetermined condition is that the file is to fit into at least one kind of file among a compressed file, an image file, a log file, a dump file and a file of first generation.

10. The storage system according to claim 1, wherein
the control unit is configured to compress the chunk read from the memory, and
the deduplication process is performed with respect to the compressed chunk, and also the compressed chunk is stored in the first or the second storage area.

11. The storage system according to claim 1, comprising:
a storage apparatus comprising the one or more storage areas and a storage control unit which performs the deduplication process, and
a host apparatus which is coupled to the storage apparatus and configured to send the file to the storage apparatus, wherein
the host apparatus comprises the memory, and a processor which judges whether or not at least one of the attribute of the file and the load of the storage system satisfies a predetermined condition and which is coupled to the memory, and
the control unit includes the memory and the processor of the host apparatus and the storage control unit.

12. The storage system according to claim 1, further comprising:
an interface unit which is coupled to a host apparatus and configured to receive the file from the host apparatus, wherein
the control unit is configured to divide the file which the interface unit received into chunks.

13. The storage system according to claim 1, wherein
the control unit is configured to read, asynchronously from the write process of the file, a chunk which the deduplication process is not performed from the first storage area, and perform the deduplication process with respect to the chunk read from the first or the second storage area.

14. A deduplication control method comprising,
storing the file in a memory of a storage system in a write process of a file,
with respect to each of multiple chunks composing the file,
reading a chunk from the memory,
performing a deduplication process with respect to the chunk read from the memory, in a case where at least one of an attribute of the file and a load of the storage system at a time of the chunk being read from the memory satisfies a predetermined condition, controlling, in the deduplication process, whether or not to write the chunk read from the memory to a second storage area, based on whether or not a chunk which duplicating the chunk read from the memory is stored in the second storage area which is one of storage areas among the one or more storage areas, and
writing the chunk read from the memory to or a first storage area which is a different storage area from the second storage area among the one or more storage areas, in a case where at least one of the attribute of the file and the load of the storage system does not satisfy the predetermined condition.

15. A host apparatus coupled to a storage apparatus which manages storage areas and performs a deduplication process, the host apparatus comprising:
an interface unit coupled to the storage apparatus,
a memory, and
a processor coupled to the memory and the interface unit,
the processor being configured to store the file in the memory in a write process of a file,
the processor being configured to, with respect to each of multiple chunks composing the file,
read a chunk from the memory,
make the storage apparatus perform a deduplication process with respect to the chunk read from the memory, in a case where at least one of an attribute of the file and a load of the storage apparatus at a time of the chunk being read from the memory satisfies a predetermined condition, and
write the chunk read from the memory to the storage area, in a case where at least one of the attribute of the file and the load of the storage apparatus does not satisfy the predetermined condition.

16. The storage system according to claim 2, wherein
the load of the storage system is a free capacity of the first storage area and a memory chunk number which is the number of chunks stored in the memory and
the predetermined condition is that the free capacity of the first storage area is less than a predetermined capacity and the memory chunk number is more than a predetermined number.

17. The storage system according to claim 10, wherein
the load of the storage system is a free capacity of the first storage area, and the control unit is configured to calculate, at each time of reading a chunk from the memory, a compression rate threshold based on the free capacity of the first storage area, and
the predetermined condition is that a compression rate of the chunk read from the memory is larger than the calculated compression rate threshold.

18. The storage system according to claim 10, wherein
The load of the storage system is a memory chunk number in which is the number of chunks stored in the memory, and
The control unit is configured to calculate, at each time of reading a chunk from the memory, a compression rate threshold based on the memory chunk number, and
The predetermined condition is that a compression rate of the chunk read from the memory is larger than the calculated compression rate threshold.
